(19) United States
(12) Patent Application Publication
(10) Pub. No.: US 2024/0033964 A1
(43) Pub. Date: Feb. 1, 2024

(54) CHUCKING ASSEMBLY AND CUTTING APPARATUS FOR GLASS LAMINATED SUBSTRATE INCLUDING THE SAME

(71) Applicant: CORNING INCORPORATED, CORNING, NY (US)

(72) Inventor: Woo Jin Lee, Cheonan (KR)

(21) Appl. No.: 18/039,999

(22) PCT Filed: Nov. 30, 2021
(86) PCT No.: PCT/US2021/061108

§ 371 Date: Jun. 2, 2023

(30) Foreign Application Priority Data
Dec. 2, 2020 (KR) 10-2020-0166976

(51) Int. Cl. B26D 7/01

(52) U.S. Cl. CPC B26D 7/015

(57) ABSTRACT

A chucking assembly includes a chucking plate having an upper surface, a lower surface, and a chucking recess in the lower surface, a lever on the upper surface of the chucking plate, a piston, a chucking pad, and an elastic member connected to the piston in the chucking recess of the chucking plate and configured to provide an elastic force to the chucking pad based on a movement of the piston.

### CROSS-REFERENCE TO RELATED APPLICATION

This application is based on and claims priority under 35 U.S.C. § 119 to Korean Patent Application No. 10-2020-0166976, filed on Dec. 2, 2020, in the Korean Intellectual Property Office, the inventive concept of which is incorporated by reference herein in its entirety.

### BACKGROUND

### 1. Field

The inventive concept relates to an apparatus for cutting a glass laminated substrate, and more particularly, to an apparatus including a chucking assembly for cutting a glass laminated substrate.

### 2. Description of Related Art

A glass laminated substrate may have a hole for various purposes such as electrical connecting, handle manufacturing, ventilation, and the like. For example, a hole may be formed in a glass laminated substrate by using techniques such as CNC routering, water jetting, or drilling. Research on an apparatus for cutting a glass laminated substrate, the apparatus being capable of reducing the generation of glass chips or debris and damage to a glass layer when a hole is formed in a glass laminated substrate, has been actively conducted.

### SUMMARY

The inventive concept provides an apparatus for cutting a glass laminated substrate, the apparatus being capable of reducing damage to a glass layer in a process of cutting a glass laminated substrate glass layer.

Furthermore, the inventive concept provides an apparatus for cutting a glass laminated substrate, whereby a hole having a uniform shape may be cut in a glass laminated substrate.

Additional aspects will be set forth in part in the description which follows and, in part, will be apparent from the description, or may be learned by practice of the presented embodiments of the inventive concept.

According to an aspect of the inventive concept, a chucking assembly of a glass laminated substrate includes a chucking plate having an upper surface, a lower surface, and a chucking recess in the lower surface, a lever on the upper surface of the chucking plate, a piston passing through the chucking plate and having one side coupled to the lever, a chucking pad connected to another side opposite to the one side of the piston, disposed on the lower surface of the chucking plate to overlap the chucking recess in a vertical direction, and configured to allow a part to move into the chucking recess of the chucking plate based on an operation of the piston, and an elastic member connected to the piston in the chucking recess of the chucking plate and configured to provide an elastic force to the chucking pad based on a movement of the piston.

In an embodiment, the chucking plate may include a paramagnetic material that is magnetized in a direction parallel to a direction of an external magnetic field.

In an embodiment, the chucking plate may include at least any one material of iron (Fe), nickel (Ni), platinum (Pt), or aluminum (Al).

In an embodiment, the chucking pad may include a plurality of chucking pads, and the plurality of chucking pads may be arranged to be symmetrical with respect to a center of the chucking plate, each of the plurality of chucking pads including at least any one material of silicone rubber or synthetic rubber.

In an embodiment, the chucking plate may have a rectangular plate shape, the plurality of chucking pads may include four chucking pads, and each of the four chucking pads may be arranged at a corner portion of the lower surface of the chucking plate.

In an embodiment, the chucking plate may have a rectangular plate shape, and the chucking plate may have a gripping hole in a portion adjacent to four sides constituting the chucking plate.

In an embodiment, the elastic member may include a coil spring, and the elastic member may surround a part of the piston exposed by the chucking recess of the chucking plate.

According to an aspect of the inventive concept, an apparatus for cutting a glass laminated substrate includes a chucking structure fixed on the glass laminated substrate and including a paramagnetic material magnetized in a direction parallel to a direction of an external magnetic field, and a hole cutting apparatus placed on the chucking structure and including: a base plate including a paramagnetic material magnetized in a direction parallel to a direction of an external magnetic field; a magnetic field generator configured to generate a magnetic field to magnetize the base plate; a cuter configured to cut a hole in the glass laminated substrate; and a controller configured to control the magnetic field generator and the cutter.

In an embodiment, the chucking structure may include a chucking plate having an upper surface, a lower surface, and a chucking recess in the lower surface, and including a paramagnetic material magnetized in a direction parallel to a direction of an external magnetic field, a lever on the upper surface of the chucking plate, a piston passing through the chucking plate and having one side coupled to the lever, a chucking pad connected to another side opposite to the one side of the piston, disposed on the lower surface of the chucking plate to overlap the chucking recess in a vertical direction, and configured to allow a part to move into the chucking recess of the chucking plate based on an operation of the piston, and an elastic member connected to the piston in the chucking recess of the chucking plate and configured to provide an elastic force to the chucking pad based on a movement of the piston.

In an embodiment, the chucking plate and the base plate may each include at least any one material of iron (Fe), nickel (Ni), platinum (Pt), or aluminum (Al).

In an embodiment, when the chucking plate is placed on the glass laminated substrate and the lever is moved to an operating state, as an edge part of the chucking pad comes in contact with the glass laminated substrate and a center part of the chucking pad is moved into the chucking recess, a space may be formed between the chucking pad and the glass laminated substrate.

In an embodiment, the chucking plate may have a rectangular plate shape, and the chucking plate may have a gripping hole in a portion adjacent to four sides constituting the chucking plate.

In an embodiment, when the controller operates the magnetic field generator, electrostatic attraction may be generated by a magnetic field generated by the magnetic field generator between the chucking plate and the base plate.

In an embodiment, the chucking pad may include any one material of synthetic rubber and silicone rubber.

In an embodiment, the upper surface of the chucking plate may include a plurality of fixed grooves having a concave shape and extending in a direction parallel to a direction in which any one side surface of side surfaces constituting the chucking plate extends.

In an embodiment, the chucking plate may have a rectangular plate shape, and the lever, the piston, the chucking pad, and the elastic member may be arranged in a corner portion of the chucking plate to be symmetrical with respect to a center of the chucking plate.

In an embodiment, the chucking structure may further include a fixed plate arranged at a corner portion of the upper surface of the chucking plate to support the lever, and the base plate of the hole cutting apparatus may be provided between the fixed plates and fixed on the chucking plate.

The hole cutting apparatus for the glass laminated substrate according to the inventive concept may include the chucking assembly fixed on the glass laminated substrate through a vacuum pressure, and the hole cutting apparatus fixed on the chucking assembly through electrostatic attraction.

In the process of cutting a glass laminated substrate, as the hole cutting apparatus may be fixed on the chucking assembly, vibrations of the hole cutting apparatus may be reduced. Accordingly, in the process of cutting a glass laminated substrate, damage to the glass layer may be reduced, and a hole having a uniform shape may be formed in the glass laminated substrate.

### BRIEF DESCRIPTION OF THE DRAWINGS

The above and other aspects, features, and advantages of certain embodiments of the inventive concept will be more apparent from the following description taken in conjunction with the accompanying drawings, in which:

FIG. 1 is a schematic cross-sectional view of a glass laminated substrate;

FIG. 2 is a plan view of a chucking assembly according to an embodiment of the inventive concept;

FIG. 3 is a bottom view of a chucking assembly according to an embodiment of the inventive concept;

FIG. 4 is a cross-sectional view of a chucking assembly according to an embodiment of the inventive concept;

FIG. 5 is a plan view of a chucking assembly in a stand-by state according to an embodiment of the inventive concept;

FIG. 6 is a cross-sectional view of a chucking assembly in a stand-by state according to an embodiment of the inventive concept;

FIG. 7 is a plan view of a chucking assembly in an operating state according to an embodiment of the inventive concept;

FIG. 8 is a cross-sectional view of a chucking assembly in an operating state according to an embodiment of the inventive concept;

FIG. 9 is a cross-sectional view of a hole cutting apparatus according to an embodiment of the inventive concept;

FIGS. 10 and 11 are views showing operations of an apparatus for cutting a glass laminated substrate according to an embodiment of the inventive concept;

FIG. 12 is a flowchart of method of cutting a hole in a glass laminated substrate according to an embodiment of the inventive concept; and

FIGS. 13 to 16 are views showing respective operations of a method of cutting a hole in a glass laminated substrate according to an embodiment of the inventive concept.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments of the inventive concept will now be described below in detail with reference to the accompanying drawings. The disclosure may, however, be embodied in many different forms and should not be construed as being limited to the embodiments set forth herein;
rather, these embodiments are provided so that this disclosure will be thorough and complete, and will fully convey the concept of the disclosure to those of ordinary skill in the art. Like reference numerals denote like constituent elements Furthermore, various elements and areas in the drawings are schematically drawn. Accordingly, the inventive concept is not limited by relative sizes or intervals drawn in the accompanying drawings.

Terms such as “first” and “second” are used herein merely to describe a variety of constituent elements, but the constituent elements are not limited by the terms. Such terms are used only for the purpose of distinguishing one constituent element from another constituent element. For example, without departing from the right scope of the disclosure, a first constituent element may be referred to as a second constituent element, and vice versa.

Terms used in the specification are used for explaining a specific embodiment, not for limiting the disclosure. An expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. Furthermore, the terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

In the drawings, the illustrated shapes may be modified according to, for example, manufacturing technology and/or tolerance. Thus, the embodiment of the disclosure may not be construed to be limited to a particular shape of a part described in the specification and may include a change in the shape generated during manufacturing, for example. As used herein, the term “and/or” includes any and all combinations of one or more of the associated listed items.

Furthermore, the term “substrate” used herein may mean a substrate by itself, or a stack structure including a substrate and a certain layer or film formed on a surface thereof. Furthermore, the term “surface of a substrate” used herein may mean an exposed surface of a substrate by itself, or an external surface such as a certain layer or film formed on the substrate.

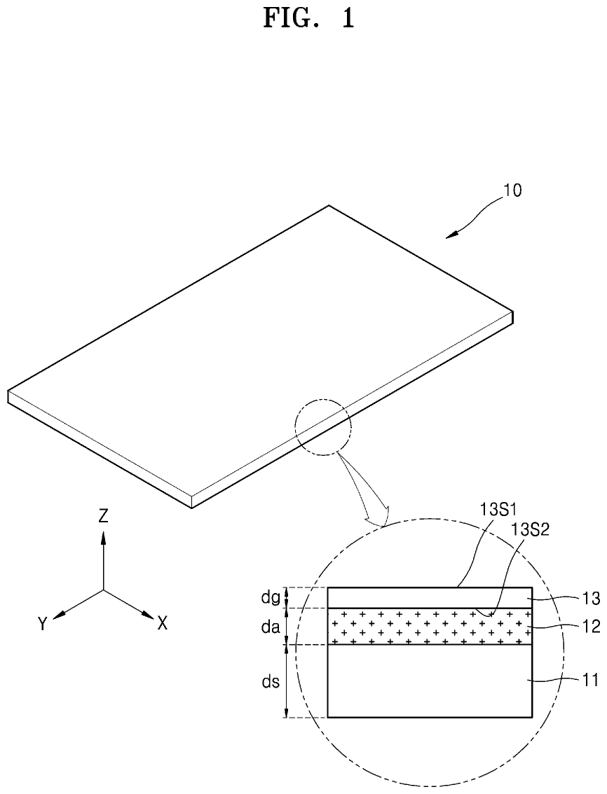

FIG. 1 is a schematic cross-sectional view of a glass laminated substrate 10.

Referring to FIG. 1, the glass laminated substrate 10 may include a substrate 11, a glass layer 13 laminated on the substrate 11, and an adhesive layer 12 for laminating the glass layer 13 on the substrate 11. For example, the glass laminated substrate 10 may be a substrate in which the substrate 11, the adhesive layer 12, and the glass layer 13 are sequentially stacked.

The substrate 11 may include a material such as metal, wood, an inorganic material, an organic material, or a combination thereof, but the disclosure is not limited thereto. For example, the substrate 11 may include a high pressure laminate (HPL), paint-coated metal (PCM), a medium density fiberboard (MDF), vinyl-coated metal (VCM), or steel, but the disclosure is not limited thereto. In an embodiment, a thickness ds of the substrate 11 may be about 500 micrometers or more.

The glass layer 13 may include, for example, borosilicate, aluminosilicate, boro-aluminosilicate, alkali-borosilicate, alkali-aluminosilicate, alkali-boro-aluminosilicate, or soda lime, but the disclosure is not limited thereto.

Among surfaces of the glass layer 13, a surface forming the top layer of the glass laminated substrate 10 may be defined to be a first surface 13S1. For example, the first surface 13S1 of the glass layer 13 may be an upper surface of the glass layer 13 exposed to the outside. Furthermore, among the surfaces of the glass layer 13, a surface contacting the adhesive layer 12 may be defined to be a second surface 13S2. For example, the second surface 13S2 of the glass layer 13 may be a lower surface of the glass layer 13 that is opposite to the first surface 13S1 and is not exposed to the outside.

In an embodiment, a thickness dg of the glass layer 13 may be about 25 micrometers or more. For example, the thickness dg of the glass layer 13 may be about 25 micrometers to about 700 micrometers. In particular, the thickness dg of the glass layer 13 may be about 100 micrometers to about 150 micrometers.

The adhesive layer 12 may be a layer for fixedly bonding the substrate 11 and the glass layer 13. For example, the adhesive layer 12 may include s pressure sensitive adhesive (PSA), optically clear resin (OCR), or optically clear adhesive (OCA), but the disclosure is not limited thereto.

In an embodiment, a thickness da of the adhesive layer 12 may be about 50 micrometers to about 300 micrometers. In particular, the thickness da of the adhesive layer 12 may be about 75 micrometers to about 125 micrometers.

In an embodiment, the glass laminated substrate 10 may further include an image film layer (not shown) between the substrate 11 and the adhesive layer 12. The image film layer may be a film formed by printing an image layer on a polymer base.

In an embodiment, the polymer base may include, for example, a polypropylene (PP) film and a polyethylene terephthalate (PET) film, a polystyrene (PS) film, an acrylonitrile butadiene styrene (ABS) resin film, a high density polyethylene (HDPE) film, a low density polyethylene (LDPE) film, a polyvinyl chloride (PVC) film, a polyethylene naphthalate film, a polybutylene terephthalate film, a polycarbonate (PC) film, or a stacked film thereof.

In an embodiment, the image layer may be a printing layer on which characters, pictures, symbols, and the like are printed. The image layer may be formed by, for example, inkjet printing or laser printing. The image layer may include a pigment component of ink for inkjet printers, or a pigment component of tone for laser printers.

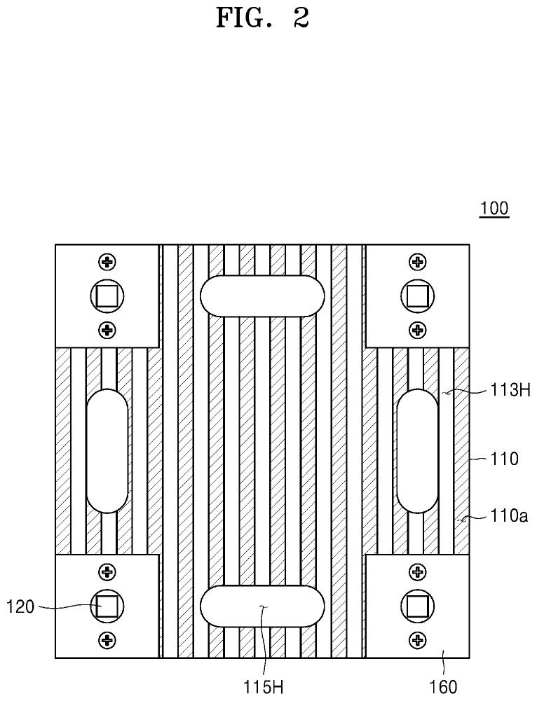

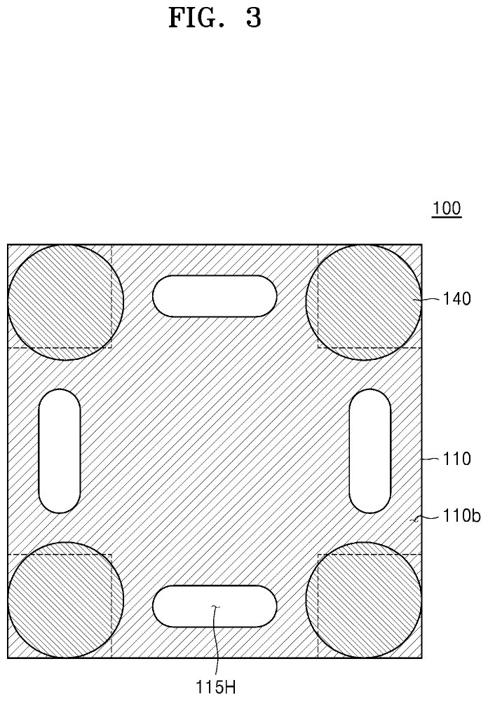

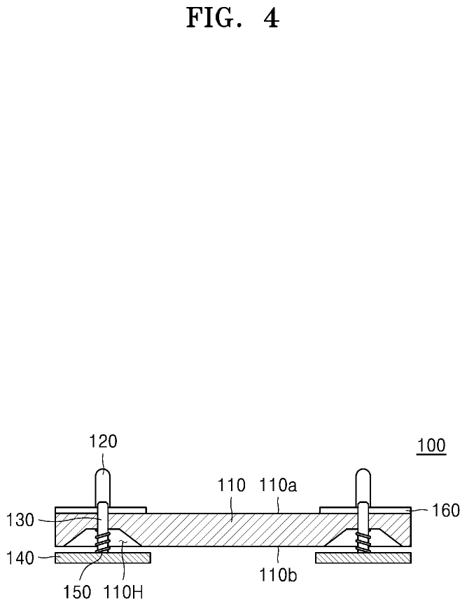

FIGS. 2 to 4 are views of a chucking assembly 100 according to an embodiment of the inventive concept. In detail, FIG. 2 is a plan view of the chucking assembly 100 according to an embodiment of the inventive concept, FIG. 3 is a bottom view of the chucking assembly 100 according to an embodiment of the inventive concept, and FIG. 4 is a cross-sectional view of the chucking assembly 100 according to an embodiment of the inventive concept.

In the following description, the chucking assembly 100 according to an embodiment of the inventive concept is described below in detail with reference to the accompanying drawings.

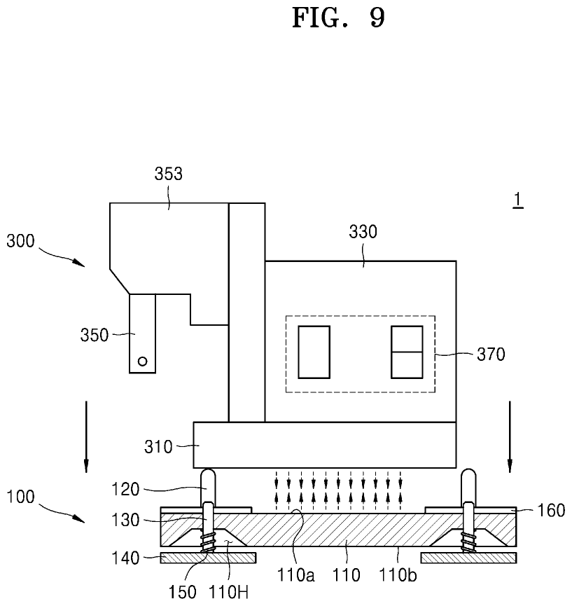

The chucking assembly 100 according to an embodiment of the inventive concept may be an assembly that is fixed by a vacuum pressure on a first surface 13S1 of the glass laminated substrate 10. Furthermore, the chucking assembly 100 may be an assembly that is provided between the first surface 13S1 of the glass laminated substrate 10 and a lower surface of a base plate 310 of a hole cutting apparatus 300 (see FIG. 9), and is configured to fix the hole cutting apparatus 300 on the first surface 13S1 of the glass laminated substrate 10.

Referring to FIGS. 2 to 4, the chucking assembly 100 according to an embodiment of the inventive concept may include a chucking plate 110, a lever 120, a piston 130, a chucking pad 140, an elastic member 150, a fixed plate 160, and the like.

The chucking plate 110 of the chucking assembly 100 may be a place having an upper surface 110a and a lower surface 110b. For example, the upper surface 110a of the chucking plate 110 may be a surface on which the hole cutting apparatus 300 of FIG. 9 to be described below is mounted, and the lower surface 110b of the chucking plate 110 may be a surface that is opposite to the upper surface 110a and faces the first surface 13S1 of the glass laminated substrate 10.

Furthermore, the chucking plate 110 may be a plate on which the lever 120, the piston 130, the chucking pad 140, the elastic member 150, the fixed plate 160, and the like are arranged. In an embodiment, the lever 120 and the fixed plate 160 may be arranged on the upper surface 110a of the chucking plate 110, and the chucking pad 140 and the elastic member 150 may be arranged on the lower surface 110b of the chucking plate 110. Furthermore, the piston 130 may be arranged to pass through the chucking plate 110.

In an embodiment, the chucking plate 110 may be a rectangular plate shape. However, the shape of the chucking plate 110 is not limited to the above description. Furthermore, the chucking plate 110 may have a chucking recess 110H in the lower surface 110b thereof. The chucking recess 110H may have a tapered shape in which a cross-sectional area thereof in a horizontal direction decreases toward the upper surface 110a of the chucking plate 110.

In an embodiment, the chucking pad 140 may be arranged on the chucking recess 110H of the chucking plate 110, a part of the chucking pad 140 may be moved by the lever 120 and the piston 130 within the chucking recess 110H.

Furthermore, the chucking plate 110 may have a fixed groove 113H in the upper surface 110a. In an embodiment, the fixed groove 113H of the chucking plate 110 may include a plurality of fixed grooves, and the fixed grooves 113H may extend parallel to a direction in which one side surface of the chucking plate 110 extends, and may have a concave shape.

For example, the upper surface 110a of the chucking plate 110 may have a plurality of the fixed grooves 113H, each having a concave shape and extending parallel to a direction in which one of side surfaces constituting the chucking plate 110 extends.

In other words, as the chucking plate 110 has the fixed grooves 113H, the upper surface 110a of the chucking plate 110 may have an uneven structure in which a concave portion and a convex portion are repeated. The fixed groove 113H of the chucking plate 110 may prevent the hole cutting apparatus 300 mounted on the upper surface 110a of the chucking plate 110 from sliding.

In an embodiment, the chucking plate 110 may have a gripping hole 115H that passes through the upper surface 110a and the lower surface 110b of the chucking plate 110 in an edge portion of the chucking plate 110. For example, the gripping hole 115H of the chucking plate 110 may be provided between the fixed plates 160. The fixed plate 160 may include a plurality of fixed plates and the fixed plates may be disposed at a corner portion of the chucking plate 110.

In an embodiment, when the chucking plate 110 has a rectangular plate shape, the gripping hole 115H may include four gripping holes that are provided at a portion adjacent to four sides constituting the chucking plate 110.

As the chucking plate 110 may include the gripping hole 115H, the chucking assembly 100 may be easily carried through the gripping hole 115H.

The lever 120 of the chucking assembly 100 may be arranged on the upper surface 110a of the chucking plate 110 and may be connected to the piston 130. In an embodiment, the lever 120 may be arranged on the fixed plate 160 mounted at a corner portion of the chucking plate 110, and a portion of the lever 120 may be connected to the piston 130.

In an embodiment, the lever 120 may be in one of a stand-by state and an operating state by a user. In the stand-by state of the lever 120, as the chucking plate 110 is not fixed on the glass laminated substrate 10, the chucking assembly 100 including the chucking plate 110 may be in a state of freely moving on the first surface 13S1 of the glass laminated substrate 10.

Furthermore, in the operating state of the lever 120, as the chucking plate 110 is fixed on the glass laminated substrate 10 by a vacuum pressure, the chucking assembly 100 including the chucking plate 110 may be in a state of being fixed on the first surface 13S1 of the glass laminated substrate 10.

Furthermore, the stand-by state of the lever 120 may be a state in which the lever 120 stands in a direction perpendicular to a direction in which the upper surface 110a of the chucking plate 110 extends. In an embodiment, when the lever 120 is in the stand-by state, the chucking pad 140 connected to the piston 130 may not be moved into the chucking recess 110H of the chucking plate 110. In other words, the chucking pad 140 may have a flat shape.

Furthermore, the operating state of the lever 120 is a state in which the lever 120 lies in a direction parallel to the direction in which the upper surface 110a of the chucking plate 110 extends. In an embodiment, when the lever 120 is in the operating state, the piston 130 may move upward and a part, for example, a center part, of the chucking pad 140 connected to the piston 130 may move into the chucking recess 110H.

The piston 130 of the chucking assembly 100 may pass through the upper surface 110a and the lower surface 110b of the chucking plate 110. Furthermore, one side of the piston 130 may be coupled to the lever 120, and the other side opposite to the one side of the piston 130 may be coupled to the chucking pad 140.

In an embodiment, a part of the piston 130 may be exposed by the chucking recess 110H of the chucking plate 110. Furthermore, the part of the piston 130 exposed by the chucking recess 110H may be connected to the elastic member 150. For example, when the elastic member 150 is a coil spring, the part of the piston 130 exposed by the chucking recess 110H may be surrounded by the elastic member 150.

In an embodiment, the piston 130 may be moved by the lever 120 in an up and down direction. For example, when the lever 120 is in the above-described operating state, the piston 130 may move upward to move the part of the chucking pad 140 into the chucking recess 110H.

The chucking pad 140 of the chucking assembly 100 may be arranged on the lower surface 110b of the chucking plate 110. In detail, the chucking pad 140 may be arranged on the lower surface 110b of the chucking plate 110 to overlap the chucking recess 110H of the chucking plate 110 in a vertical direction.

In an embodiment, the chucking pad 140 may be configured to move in the up and down direction based on the operation of the piston 130. For example, the center portion of the chucking pad 140 may be connected to the piston 130. The piston 130 may move upward based on the operation of the lever 120. Furthermore, the center portion of the chucking pad 140 connected to the piston 130 may move upward to be arranged inside the chucking recess 110H or may be arranged outside the chucking recess 110H.

In an embodiment, the chucking pad 140 may include an elastic material. For example, the chucking pad 140 may include at least any one material of silicone rubber and synthetic rubber.

In an embodiment, as the chucking pad 140 may include silicone rubber and synthetic rubber, physical damage to the glass laminated substrate 10 may be prevented. For example, cracks of the glass laminated substrate 10 and a warpage phenomenon of the glass laminated substrate 10 may be reduced.

In an embodiment, the chucking pad 140 may include a plurality of chucking pads. When the chucking plate 110 has a rectangular plate shape, the chucking pad 140 may include four chucking pads. For example, each of the four chucking pads 140 may be arranged at the corner portion of the chucking plate 110. Furthermore, each of the four chucking pads 140 may be arranged on the lower surface of the chucking plate 110 to overlap the chucking recess 110H of the chucking plate 110 in the vertical direction.

In an embodiment, when the lever 120 is in the operating state, the piston 130 may apply an upward external force to the chucking pad 140. Accordingly, the chucking pad 140 may be bent in a direction toward the chucking recess 110H. When the chucking pad 140 is bent in the direction toward the chucking recess 110H, the chucking assembly 100 may be coupled to the glass laminated substrate 10 by a vacuum pressure provided by the space between the chucking pad 140 and the glass laminated substrate 10.

In an embodiment, when the operating state of the lever 120 is removed, that is, the lever 120 is in the stand-by state, the piston 130 may move the chucking pad 140 downward. At this time, the chucking pad 140 is not bent in the direction toward the chucking recess 110H and may keep the flat shape. Furthermore, when the operating state of the lever 120 is removed, the vacuum pressure provided by the space between the chucking pad 140 and the glass laminated substrate 10 may be removed, and thus the chucking assembly 100 may be separated from the glass laminated substrate 10.

The elastic member 150 of the chucking assembly 100 is located in the chucking recess 110H of the chucking plate 110, and may be configured to provide an elastic force in a direction perpendicular to the chucking pad 140. In an embodiment, the elastic member 150 may be configured to provide an elastic force in the direction perpendicular to the chucking pad 140, based on the movement of the piston 130.

In an embodiment, the elastic member 150 may have a coil spring shape, and the elastic member 150 may surround the part of the piston 130 exposed by the chucking recess 110H.

For example, when the piston 130 is moved upward by the lever 120, the elastic member 150 may be compressed to provide a downward elastic force to the chucking pad 140.

The fixed plate 160 of the chucking assembly 100 may be arranged on the upper surface 110a of the corner portion of the chucking plate 110, and may support the lever 120. Furthermore, the fixed plate 160 may be arranged to protrude from the upper surface 110a of the chucking plate 110.

Furthermore, the fixed plate 160 may be configured to fix the lever 120 on the upper surface 110a of the chucking plate 110. The fixed plate 160 may be fixed on the upper surface 110a of the chucking plate 110 using a fastening member such as bolts and nut.

In an embodiment, the fixed plate 160 may be configured to fix the hole cutting apparatus 300 on the upper surface 110a of the chucking plate 110. In detail, the hole cutting apparatus 300 of FIG. 9 may be arranged between the fixed plates 160, and the hole cutting apparatus 300 may be provided between the fixed plates 160 and fixed on the upper surface 110a of the chucking plate 110.

As the chucking assembly 100 according to an embodiment of the inventive concept includes the lever 120, the piston 130, the chucking pad 140, and the like, during cutting of the glass laminated substrate 10, the chucking assembly 100 may firmly fixed on the first surface 13S1 of the glass laminated substrate 10.

Furthermore, the chucking assembly 100 according to an embodiment of the inventive concept may include the chucking plate 110 including a paramagnetic material that is magnetized in a direction parallel to the direction of a magnetic field, during the cutting of the glass laminated substrate 10, the hole cutting apparatus 300 of FIG. 9 and the chucking assembly 100 may be firmly coupled to each other by an electromagnetic force.

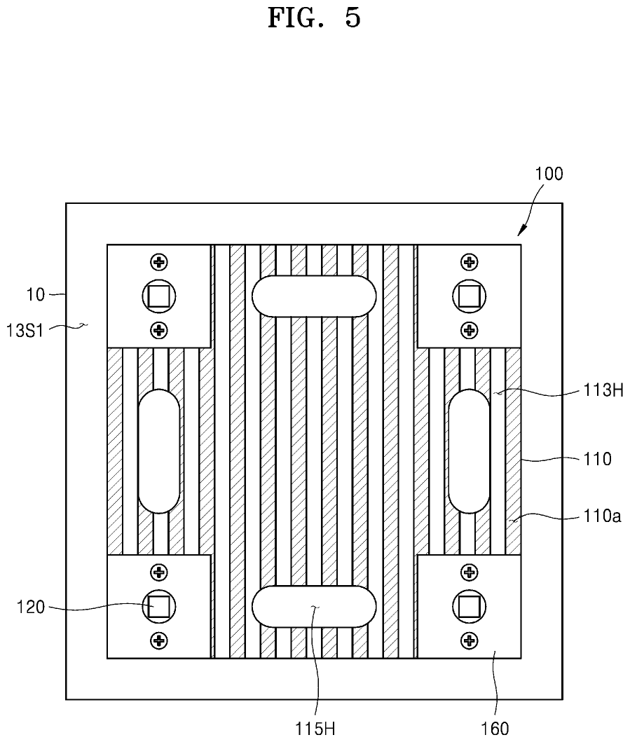

In the following description, the operation method of the chucking assembly 100 according to an embodiment of the inventive concept is described in detail with reference to FIGS. 5 to 8.

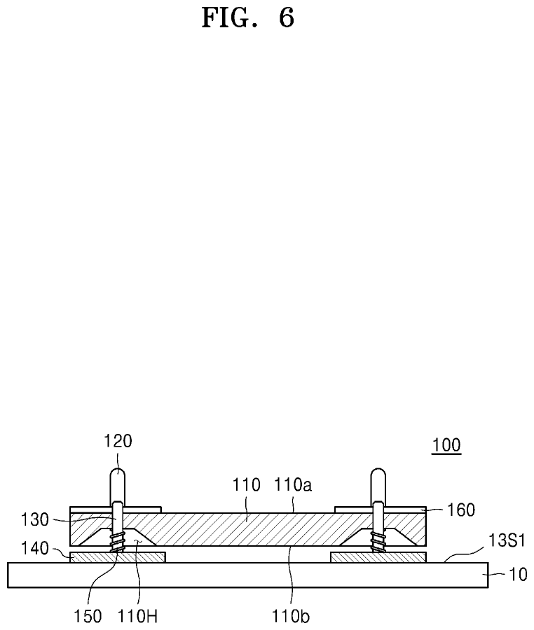

FIG. 5 is a plan view of the chucking assembly 100 in a stand-by state according to an embodiment of the inventive concept. Furthermore, FIG. 6 is a cross-sectional view of the chucking assembly 100 in a stand-by state according to an embodiment of the inventive concept.

In an embodiment, the stand-by state of the chucking assembly 100 may be a state in which the chucking assembly 100 is not fixed on the glass laminated substrate but is capable of moving on the first surface 13S1 of the glass laminated substrate 10.

In an embodiment, in the stand-by state of the chucking assembly 100, the lever 120 may stand in a direction perpendicular to the direction in which the upper surface 110a of the chucking plate 110 extends. Furthermore, the chucking pad 140 may remain on the lower surface 110b of the chucking plate 110 in a state of keeping a flat shape, without moving into the chucking recess 110H of the chucking plate 110.

In an embodiment, in the stand-by state of the chucking assembly 100, the center portion and an edge portion of the chucking pad 140 may be in contact with the first surface 13S1 of the glass laminated substrate 10. Accordingly, the chucking pad 140 of the chucking assembly 100 may not provide a vacuum pressure to the glass laminated substrate 10, and the chucking assembly 100 may not be fixed on the glass laminated substrate 10.

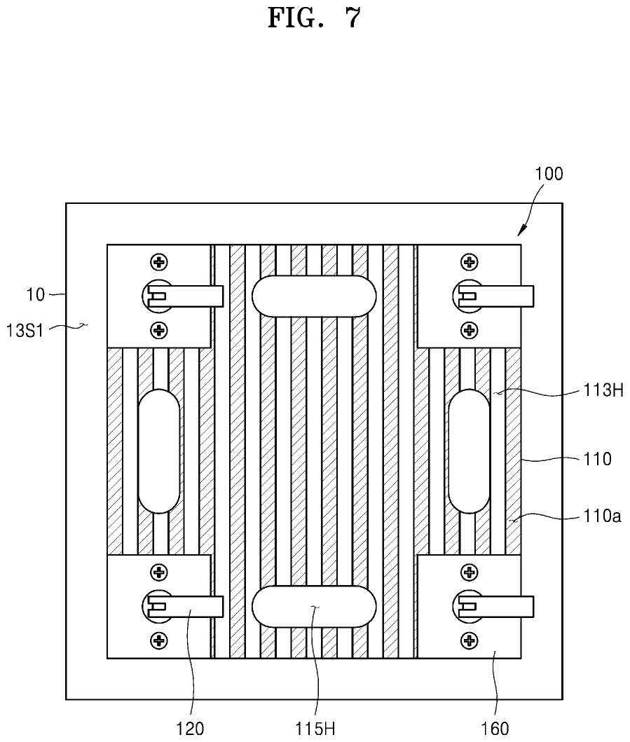

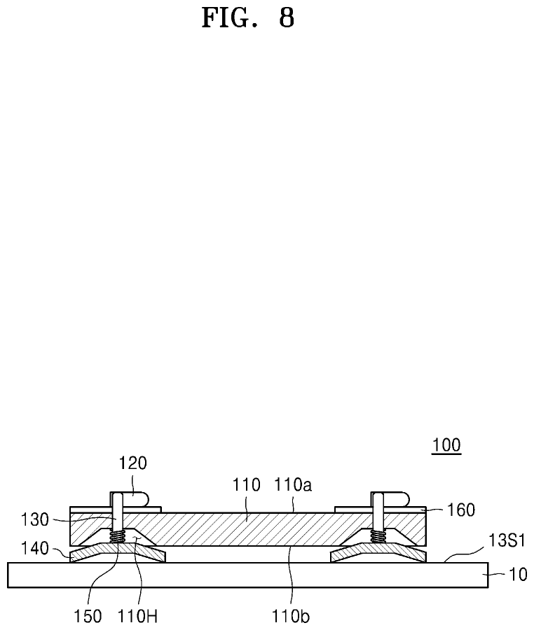

FIG. 7 is a plan view of the chucking assembly 100 in an operating state according to an embodiment of the inventive concept. Furthermore, FIG. 8 is a cross-sectional view of the chucking assembly 100 in an operating state according to an embodiment of the inventive concept.

In an embodiment, the operating state of the chucking assembly 100 may be a state in which the chucking assembly 100 is fixed on the glass laminated substrate 10, and the chucking assembly 100 does not move on the first surface 13S1 of the glass laminated substrate 10.

In an embodiment, in the operating state of the chucking assembly 100, the lever 120 may lie in a direction parallel to the direction in which the upper surface 110a of the chucking plate 110 extends. Furthermore, the piston 130 may perform an upward movement by the lever 120, and the piston 130 may apply an upward external force to the chucking pad 140.

Accordingly, as the center portion of the chucking pad 140 moves into the chucking recess 110H of the chucking plate 110 to be separated from the first surface 13S1 of the glass laminated substrate 10, and the edge portion of the chucking pad 140 may be in contact with the first surface 13S1 of the glass laminated substrate 10.

In an embodiment, in the operating state of the chucking assembly 100, a space may be formed between the chucking pad 140 and the glass laminated substrate 10, and the chucking assembly 100 may be coupled to the glass laminated substrate 10 by the vacuum pressure supplied by the space.

FIG. 9 is a cross-sectional view of a hole cutting apparatus 300 according to an embodiment of the inventive concept.

The hole cutting apparatus 300 according to an embodiment of the inventive concept may be mounted on the chucking plate 110 of the chucking assembly 100 and configured to cut a hole in the glass laminated substrate 10. In detail, the hole cutting apparatus 300 may be configured to cut a hole in the glass laminated substrate in a state of being fixed on the upper surface 110a of the chucking plate 110 of the chucking assembly 100 by an electromagnetic force.

Referring to FIG. 9, the hole cutting apparatus 300 according to an embodiment of the inventive concept may include the base plate 310, a magnetic field generator 330, a cutter 350, a controller 370, and the like.

The base plate 310 of the hole cutting apparatus 300 may be configured to support a plurality of constituent elements of the hole cutting apparatus 300. In detail, the magnetic field generator 330, the cutter 350, the controller 370, and the like may be mounted on the base plate 310.

In an embodiment, the base plate 310 may include a paramagnetic material magnetized in a direction parallel to a direction of a magnetic field. In other words, when a magnetic field is applied to the outside of the base plate 310, the base plate 310 may be magnetized to function as a magnet. Furthermore, when the magnetic field is removed from the outside of the base plate 310, the magnetism of the base plate 310 may be removed.

In an embodiment, the base plate 310 may include at least any one material of iron (Fe), nickel (Ni), and platinum (Pt). In detail, the base plate 310 may include at least any one material of iron (Fe) and stainless steel.

As the base plate 310 of the hole cutting apparatus 300 according to an embodiment of the inventive concept may include a paramagnetic material, the base plate 310 may be coupled to the chucking plate 110 of the chucking assembly 100 by electrostatic attraction.

In an embodiment, the base plate 310 may be mounted on the upper surface 110a of the chucking plate 110 of the chucking assembly 100. Furthermore, the base plate 310 may be provided between the fixed plates 160 of the chucking assembly 100.

For example, the length of the base plate 310 in the horizontal direction may be substantially the same as a separation distance of the fixed plate 160 in the horizontal direction. As the side surface of the base plate 310 may be inserted between the side surfaces of the fixed plates 160 of the chucking assembly 100, escape of the base plate 310 in the horizontal direction may be prevented.

The magnetic field generator 330 of the hole cutting apparatus 300 according to an embodiment of the inventive concept may be mounted on the base plate 310 and may be configured to generate a magnetic field to magnetize the base plate 310.

In an embodiment, the magnetic field generator 330 may include a lead wire (not shown) of a conductive material, a current application device (not shown) configured to apply a current to the lead wire, and the like. For example, the lead wire may have a spring shape, and when a current is applied to the lead wire, a magnetic field may be formed inside the lead wire and outside the lead wire.

In an embodiment, when the magnetic field generator 330 is operated, that is, the current application device applies to a current to the lead wire), a magnetic field may be generated around the base plate 310. Furthermore, the base plate 310 may be magnetized in a direction parallel to the direction of the magnetic field.

Furthermore, when the magnetic field generator 330 is operated, the chucking plate 110 of the chucking assembly 100 may be also magnetized in the direction parallel to the direction of the magnetic field. Accordingly, the base plate 310 of the hole cutting apparatus 300 may be firmly fixed on the chucking plate 110 of the chucking assembly 100 by electrostatic attraction.

Furthermore, when the magnetic field generator 330 is not operated, that is, the current application device removes the application of current to the lead wire, the magnetic field may disappear from the base plate 310 and the vicinity thereof.

Accordingly, the electrostatic attraction between the base plate 310 and the chucking plate 110 may be removed, and the hole cutting apparatus 300 may move on the upper surface 110a of the chucking plate 110.

The cutter 350 of the hole cutting apparatus 300 may be configured to cut a hole in the glass laminated substrate 10. In detail, the cutter 350 may be configured to cut, through rotation, a hole in the glass laminated substrate 10.

In an embodiment, the cutter 350 may be configured to cut a hole that passes through at least a part of the glass layer 13 and the adhesive layer 12 of the glass laminated substrate 10. However, the disclosure is not limited thereto, and the cutter 350 may be configured to form a hole that passes through only the glass layer 13 of the glass laminated substrate 10, or all of the glass layer 13, the adhesive layer 12, and the substrate 11.

Furthermore, during the hole cutting of the glass laminated substrate 10, a cutter casing 353 connected to the cutter 350 may move in the vertical direction. For example, the cutter casing 353 may be slidably coupled to a part of the hole cutting apparatus 300, and the cutter casing 353 may move in the vertical direction by a sliding movement.

The controller 370 may generally control the hole cutting apparatus 300. In an embodiment, the controller 370 may be connected to the magnetic field generator 330 and the cutter 350.

In an embodiment, the controller 370 may control the magnetic field generator 330 to generate electrostatic attraction between the base plate 310 of the hole cutting apparatus 300 and the chucking plate 110 of the chucking assembly 100.

In an embodiment, when the controller 370 transmits an operation signal to the magnetic field generator 330, the magnetic field generator 330 may generate a magnetic field around the base plate 310 and the chucking plate 110.

Accordingly, the base plate 310 and the chucking plate 110 may be magnetized in a direction parallel to the direction of the magnetic field generated by the magnetic field generator 330, and the base plate 310 may be firmly fixed on the upper surface 110a of the chucking plate 110 by electrostatic attraction.

Furthermore, when the controller 370 stops the transmission of an operation signal to the magnetic field generator 330, the magnetic field generator 330 may not generate a magnetic field around the base plate 310 and the chucking plate 110.

Accordingly, the base plate 310 and the chucking plate 110 may not be magnetized, and the base plate 310 may move, instead of being fixed on the upper surface 110a of the chucking plate 110.

In an embodiment, the controller 370 may control the cutter 350. For example, the controller 370 may control at least any one of a rotation direction and a rotation speed of the cutter 350. Furthermore, the controller 370 may control a vertical movement of the cutter casing 353.

In an embodiment, the controller 370 may be implemented by hardware, firmware, software, or a combination thereof. For example, the controller 370 may be a computing device such as a workstation computer, a desktop computer, a laptop computer, a tablet computer, and the like.

In an embodiment, the controller 370 may be a simple controller, a complex processor such as a microprocessor, a CPU, a GPU, and the like, a processor configured by software, dedicated hardware, or firmware. The controller 370 may be implemented by application specific hardware, for example, a general purpose computer, a digital signal processor (DSP), a field programmable gate array (FPGA), an application specific integrated circuit (ASIC), and the like.

In an embodiment, the operation of the controller 370 may be implemented by instructions stored on a machine readable medium that can be read and executed by one or more processors. The machine readable medium may include a mechanism for storing and/or transmitting information in the form of being capable of read by machine, for example, a computing device. For example, the machine readable medium may include read only memory (ROM), random access memory (RAM), a magnetic disk storage medium, an optical storage medium, a flash memory device, electrical, optical, acoustic, or other forms of radio wave signals, for example, carrier, infrared signal, digital signal, etc., and other arbitrary signals Furthermore, the controller 370 may be implemented by firmware, software, routine, and instructions for general control of the hole cutting apparatus 300.

When the hole cutting apparatus 300 is mounted on the first surface 13S1 of the glass laminated substrate 10 and cuts a hole in the glass laminated substrate 10, the glass layer 13 of the glass laminated substrate 10 may be possibly damaged due to the vibration of the hole cutting apparatus 300. Furthermore, due to the vibration of the hole cutting apparatus 300, the shape of a hole generated in the glass laminated substrate 10 may not be uniform.

The hole cutting apparatus 300 according to an embodiment of the inventive concept may include the base plate 310 that is magnetized based on the operation of the magnetic field generator 330. The hole cutting apparatus 300 may be firmly fixed on the upper surface 110a of the chucking plate 110 of the chucking assembly 100 that forms electrostatic attraction with the base plate 310.

As the hole cutting apparatus 300 in a state of being firmly fixed on the chucking assembly 100 cuts a hole in the glass laminated substrate 10, the vibration of the hole cutting apparatus 300 may be reduced. Accordingly, the risk of damage to the glass layer 13 of the glass laminated substrate 10 may be reduced, and the shape of a hole in the glass laminated substrate 10 generated by the hole cutting apparatus 300 may be uniform.

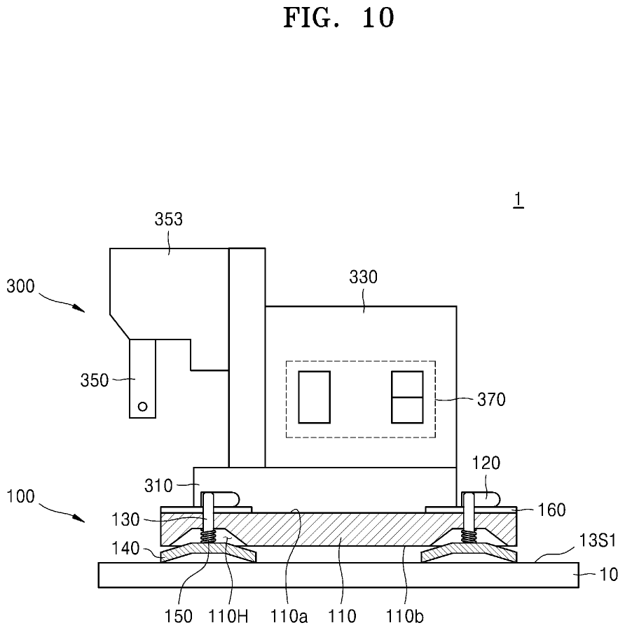

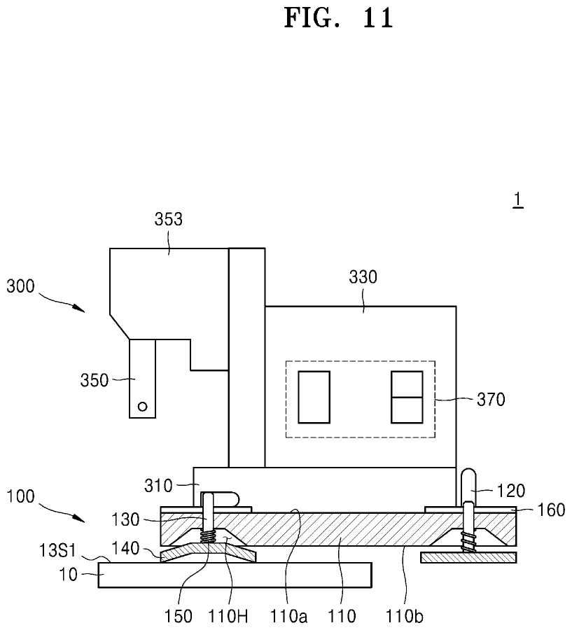

FIGS. 10 and 11 are views of an operation of a cutting apparatus 1 of the glass laminated substrate 10 according to an embodiment of the inventive concept.

The cutting apparatus 1 of the glass laminated substrate 10 according to an embodiment of the inventive concept may include the chucking assembly 100 and the hole cutting apparatus 300 according to the above-described embodiment of the inventive concept. As the descriptions of the chucking assembly 100 and the hole cutting apparatus 300 are the same as the descriptions presented above, detailed descriptions thereof are omitted.

Referring to FIG. 10, the cutting apparatus 1 of the glass laminated substrate may be configured to cut a hole in the glass laminated substrate 10 having the first surface 13S1 having an area greater than the area of the lower surface 110b of the chucking plate 110 of the chucking assembly 100.

In an embodiment, the chucking assembly 100 may include a plurality of levers as the lever 120, a plurality of pistons as the piston 130, a plurality of chucking pads as the chucking pad 140, and a plurality of elastic members as the elastic member 150. For example, when the chucking plate 110 has a rectangular shape, the lever 120, the piston 130, the chucking pad 140, and the elastic member 150 respectively include four levers, four pistons, four chucking pads, and four elastic members, which may be respectively arranged at corner portions having a rectangular shape.

In an embodiment, among the levers 120 of the chucking assembly 100, the levers 120 overlapping the first surface 13S1 of the glass laminated substrate 10 in the vertical direction may be operated. In other words, among the chucking pads 140 of the chucking assembly 100, the chucking pads 140 overlapping the first surface 13S1 of the glass laminated substrate 10 in the vertical direction may be operated.

For example, as illustrated in FIG. 10, when four levers 120 of the chucking assembly 100 overlap the first surface 13S1 of the glass laminated substrate 10 in the vertical direction, the four levers 120 are all operated so that the chucking plate 110 may be fixed on the first surface 13S1 of the glass laminated substrate 10 by the vacuum pressure provided by the chucking pads 140 to the glass laminated substrate 10.

Referring to FIG. 11, the cutting apparatus 1 of the glass laminated substrate 10 may be configured to cut a hole in the glass laminated substrate 10 having the first surface 13S1 having an area less than the area of the lower surface 110b of the chucking plate 110 of the chucking assembly 100.

In an embodiment, among the levers 120 of the chucking assembly 100, the levers 120 overlapping the first surface 13S1 of the glass laminated substrate 10 in the vertical direction may be operated. In other words, among the chucking pads 140 of the chucking assembly 100, the chucking pads 140 overlapping the first surface 13S1 of the glass laminated substrate 10 in the vertical direction may be operated.

For example, as illustrated in FIG. 11, when only two of four levers 120 of the chucking assembly 100 overlap the first surface 13S1 of the glass laminated substrate in the vertical direction, only the two levers 120 may be operated. Furthermore, the chucking plate 110 may be fixed on the first surface 13S1 of the glass laminated substrate 10 by the vacuum pressure provided by the chucking pads 140 connected to the two levers 120 to the glass laminated substrate 10.

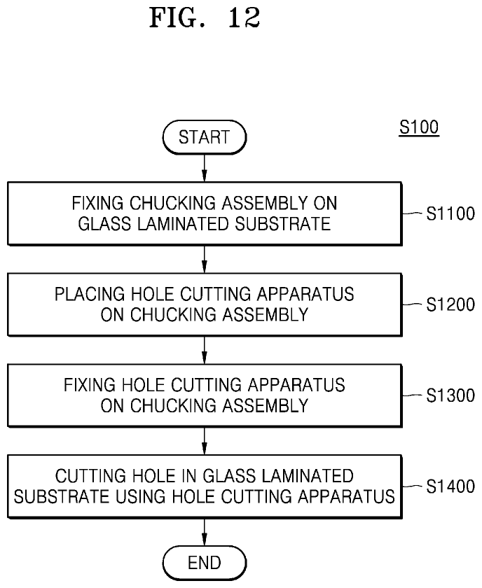

In the following description, a method of cutting a hole in the glass laminated substrate 10 using the cutting apparatus 1 of the glass laminated substrate 10 according to an embodiment of the inventive concept is described with reference to FIGS. 12 to 16. The cutting apparatus 1 of the glass laminated substrate 10 according to an embodiment of the inventive concept may include the chucking assembly 100 and the hole cutting apparatus 300.

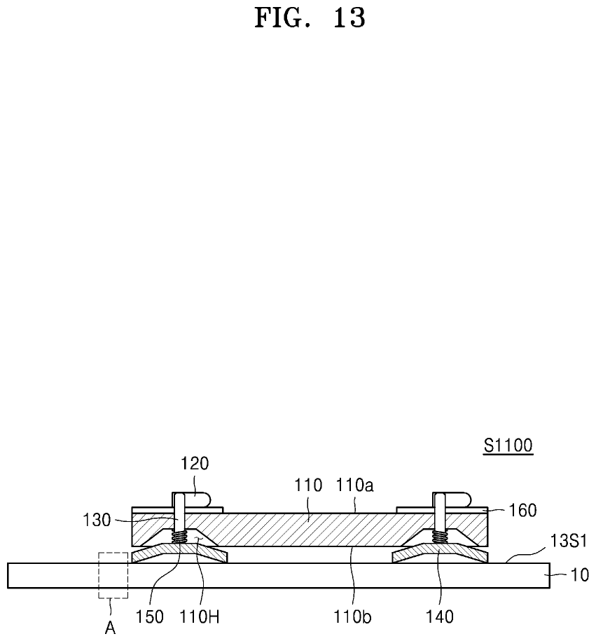

FIG. 12 is a flowchart of a hole cutting method S100 of the glass laminated substrate 10 according to an embodiment of the inventive concept. Furthermore, FIGS. 13 to 16 are views of respective operations of the hole cutting method S100 of the glass laminated substrate 10 according to an embodiment of the inventive concept.

Referring to FIG. 12, the hole cutting method S100 of the glass laminated substrate 10 according to an embodiment of the inventive concept may include fixing the chucking assembly 100 on the glass laminated substrate 10 (S1100), placing the hole cutting apparatus 300 on the chucking assembly 100 (S1200), fixing the hole cutting apparatus 300 on the chucking assembly 100 (S1300), cutting a hole in the glass laminated substrate 10 using the hole cutting apparatus 300 (S1400), and the like.

Referring to FIGS. 12 and 13 together, the hole cutting method S100 of the glass laminated substrate 10 according to an embodiment of the inventive concept may include the fixing of the chucking assembly 100 on the glass laminated substrate (S1100).

The operation S1100 may include aligning the position of the chucking assembly 100, and fixing the chucking assembly 100 on the first surface 13S1 of the glass laminated substrate 10.

In the aligning of the position of the chucking assembly 100, the chucking assembly 100 may freely move on the first surface 13S1 of the glass laminated substrate 10. In other words, as the lever 120 of the chucking assembly 100 may be in a stand-by state, the chucking pad 140 may not provide a suction pressure to the glass laminated substrate 10. Accordingly, the chucking assembly 100 may not be fixed on the first surface 13S1 of the glass laminated substrate 10.

Furthermore, the chucking assembly 100 may be arranged at a portion adjacent to a cutting portion A of the glass laminated substrate 10. The cutting portion A of the glass laminated substrate 10 may be defined to be a portion of the glass laminated substrate 10 where a hole is formed by the hole cutting apparatus 300.

After the chucking assembly 100 is arranged at the portion adjacent to the cutting portion A of the glass laminated substrate 10, the lever 120 of the chucking assembly 100 may be operated. In other words, the lever 120 of the chucking assembly 100 may move in a state of lying in a direction parallel to the direction in which the upper surface 110a of the chucking plate 110 extends.

In an embodiment, when the lever 120 of the chucking assembly 100 is in an operating state, the piston 130 may move upward, and the center portion of the chucking pad 140 connected to the piston 130 may move into the chucking recess 110H.

Accordingly, the center portion of the chucking pad 140 may move into the chucking recess 110H of the chucking plate 110 to be separated from the first surface 13S1 of the glass laminated substrate 10, and the edge portion of the chucking pad 140 may be in contact with the first surface 13S1 of the glass laminated substrate 10.

In an embodiment, in the operating state of the lever 120 of the chucking assembly 100, a space may be formed between the chucking pad 140 and the glass laminated substrate 10, and the chucking assembly 100 may be firmly fixed on the first surface 13S1 of the glass laminated substrate 10 by the vacuum pressure provided by the space.

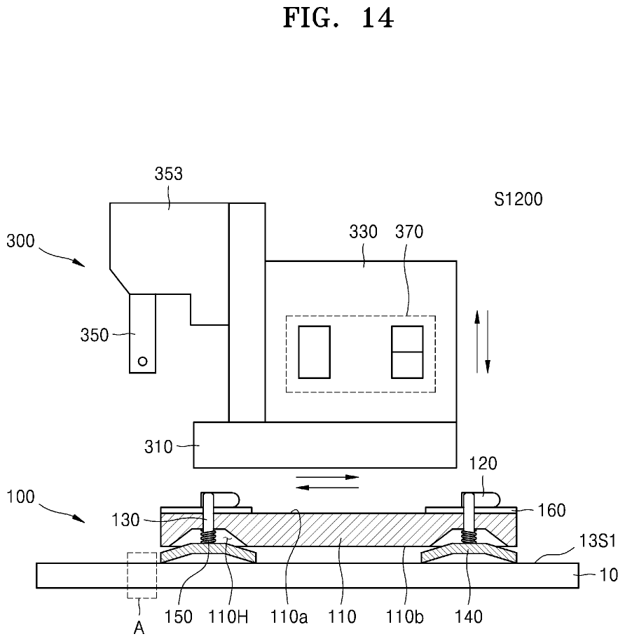

Referring to FIGS. 12 and 14 together, the hole cutting method S100 of the glass laminated substrate 10 according to an embodiment of the inventive concept may include the placing of the hole cutting apparatus 300 on the chucking assembly 100 (S1200).

In the operation S1200, the hole cutting apparatus 300 may be mounted on the upper surface 110a of the chucking plate 110 of the chucking assembly 100. Furthermore, in the operation S1200, the base plate 310 of the hole cutting apparatus 300 and the chucking plate 110 of the chucking assembly 100 may be in contact with each other.

In an embodiment, in the operation S1200, the hole cutting apparatus 300 may be mounted on the upper surface 110a of the chucking plate 110 so that the base plate 310 of the hole cutting apparatus 300 is provided between the fixed plates 160 of the chucking assembly 100.

In an embodiment, in the operation S1200, the magnetic field generator 330 of the hole cutting apparatus 300 may not be operated. In other words, in the operation S1200, the current application device of the magnetic field generator 330 may not apply a current to the lead wire.

Accordingly, in the operation S1200, electrostatic attraction may not be generated between the base plate 310 of the hole cutting apparatus 300 and the chucking plate 110 of the chucking assembly 100.

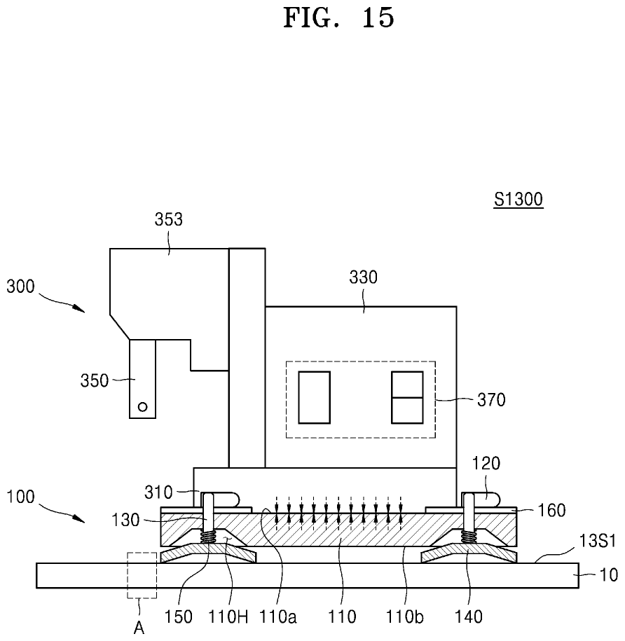

Referring to FIGS. 12 and 15 together, the hole cutting method S100 of the glass laminated substrate 10 according to an embodiment of the inventive concept may include the fixing of the hole cutting apparatus 300 on the chucking assembly 100 (S1300).

In the operation S1300, the hole cutting apparatus 300 may be fixed on the chucking assembly 100 by electrostatic attraction.

In an embodiment, in the operation S1300, the magnetic field generator 330 of the hole cutting apparatus 300 may be operated. In other words, the magnetic field generator 330 may generate a magnetic field around the base plate 310 of the hole cutting apparatus 300 and the chucking plate 110 of the chucking assembly 100.

Furthermore, when the magnetic field generator 330 of the hole cutting apparatus 300 is operated, the chucking plate 110 of the chucking assembly 100 and the base plate 310 of the hole cutting apparatus 300 may be magnetized in a direction parallel to the direction of the magnetic field generated by the magnetic field generator 330.

Accordingly, the base plate 310 of the hole cutting apparatus 300 may be firmly fixed on the upper surface 110a of the chucking plate 110 of the chucking assembly 100 by the electrostatic attraction.

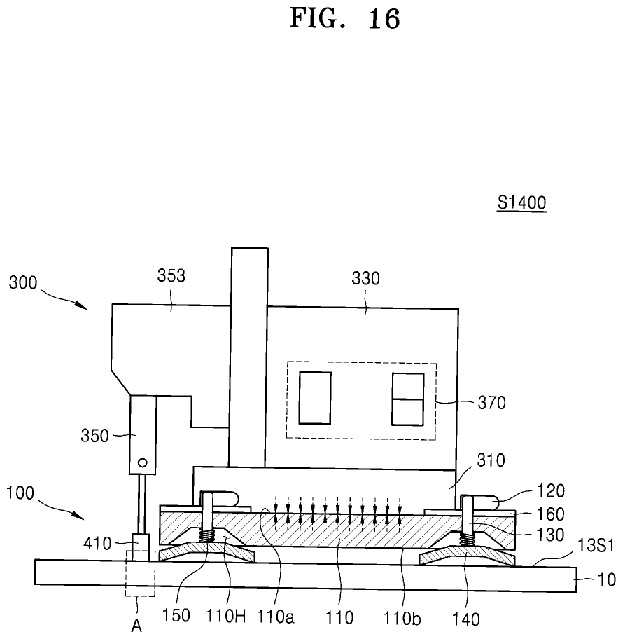

Referring to FIGS. 12 and 16 together, the hole cutting method S100 of the glass laminated substrate 10 according to an embodiment of the inventive concept may include the cutting of a hole in the glass laminated substrate 10 using the hole cutting apparatus 300 (S1400).

In the operation S1400, the cutter 350 of the hole cutting apparatus 300 may cut a hole in the glass laminated substrate 10. In detail, the cutter 350 may rotate around an axis in a direction perpendicular to the direction in which the first surface 13S1 of the glass laminated substrate 10 extends, and the cutter 350 may etch a part of the glass layer 13 and the adhesive layer 12 of the glass laminated substrate 10.

In an embodiment, in the operation S1400, a cutter guide 410 may be additionally used. The cutter guide 410 may be configured to surround a drill of the cutter 350 and prevent escape of the drill in the horizontal direction.

The cutting apparatus 1 of the glass laminated substrate 10 according to an embodiment of the inventive concept may include the chucking assembly 100 fixed on the glass laminated substrate 10 by the vacuum pressure and the hole cutting apparatus 300 fixed on the chucking assembly 100 by the electrostatic attraction.

The hole cutting method S100 of the glass laminated substrate 10 according to an embodiment of the inventive concept may include the fixing of the chucking assembly 100 on the glass laminated substrate 10 through the vacuum pressure, and the fixing of the hole cutting apparatus 300 on the chucking assembly 100 through the electrostatic attraction.

As the hole cutting apparatus 300 can cut a hole in the glass laminated substrate 10 in a state of being firmly fixed on the chucking assembly 100, the vibration of the hole cutting apparatus 300 may be reduced. Accordingly, the risk of damage to the glass layer 13 of the glass laminated substrate 10 may be reduced, and the shape of a hole in the glass laminated substrate 10 generated by the hole cutting apparatus 300 may be uniform.

Although the configuration and effect of the inventive concept are described above in detail with specific embodiments and comparative examples, the embodiments of the inventive concept are provided to have the inventive concept to be clearly understood, not to limit the scope of the inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the inventive concept as defined by the following claims.

1. A chucking assembly of a glass laminated substrate, the chucking assembly comprising:
a chucking plate having an upper surface, a lower surface, and a chucking recess in the lower surface;
a lever on the upper surface of the chucking plate;
a piston passing through the chucking plate and having one side coupled to the lever;
a chucking pad connected to another side opposite to the one side of the piston, disposed on the lower surface of the chucking plate to overlap the chucking recess in a vertical direction, and configured to allow a part to move into the chucking recess of the chucking plate based on an operation of the piston; and
an elastic member connected to the piston in the chucking recess of the chucking plate and configured to provide an elastic force to the chucking pad based on a movement of the piston.

2. The chucking assembly of claim 1, wherein the chucking plate comprises a paramagnetic material that is magnetized in a direction parallel to a direction of an external magnetic field.

3. The chucking assembly of claim 1, wherein the chucking plate comprises at least any one material of iron (Fe), nickel (Ni), platinum (Pt), or aluminum (Al).

4. The chucking assembly of claim 1, wherein the chucking pad comprises a plurality of chucking pads, and the plurality of chucking pads are arranged to be symmetrical with respect to a center of the chucking plate, each of the plurality of chucking pads comprising at least any one material of silicon rubber or synthetic rubber.

5. The chucking assembly of claim 4, wherein the chucking plate has a rectangular plate shape, the plurality of chucking pads comprise four chucking pads, and each of the four chucking pads is arranged at a corner portion of the lower surface of the chucking plate.

6. The chucking assembly of claim 1, wherein the chucking plate has a rectangular plate shape, and the chucking plate has a gripping hole in a portion adjacent to four sides constituting the chucking plate.

7. The chucking assembly of claim 1, wherein the elastic member comprises a coil spring, and the elastic member surrounds a part of the piston exposed by the chucking recess of the chucking plate.

8. An apparatus for cutting a glass laminated substrate, the apparatus comprising:
a chucking structure fixed on the glass laminated substrate and comprising a paramagnetic material magnetized in a direction parallel to a direction of an external magnetic field; and
a hole cutting apparatus placed on the chucking structure and comprising: a base plate comprising a paramagnetic material magnetized in a direction parallel to a direction of an external magnetic field; a magnetic field generator configured to generate a magnetic field to magnetize the base plate; a cuter configured to cut a hole in the glass laminated substrate; and
a controller configured to control the magnetic field generator and the cutter.

9. The apparatus of claim 8, wherein the chucking structure comprises:
a chucking plate having an upper surface, a lower surface, and a chucking recess in the lower surface, and comprising a paramagnetic material magnetized in a direction parallel to a direction of an external magnetic field;
a lever on the upper surface of the chucking plate;
a piston passing through of the chucking plate and having one side coupled to the lever;
a chucking pad connected to another side opposite to the one side of the piston, disposed on the lower surface of the chucking plate to overlap the chucking recess in a vertical direction, and configured to allow a part to move into the chucking recess of the chucking plate based on an operation of the piston; and
an elastic member connected to the piston in the chucking recess of the chucking plate and configured to provide an elastic force to the chucking pad based on a movement of the piston.

10. The apparatus of claim 9, wherein the chucking plate and the base plate comprises at least any one material of iron (Fe), nickel (Ni), platinum (Pt), or aluminum (Al).

11. The apparatus of claim 9, wherein, when the chucking plate is placed on the glass laminated substrate and the lever is moved to an operating state, as an edge part of the chucking pad comes in contact with the glass laminated substrate and a center part of the chucking pad is moved into the chucking recess, a space is formed between the chucking pad and the glass laminated substrate.

12. The apparatus of claim 9, wherein the chucking plate has a rectangular plate shape, and the chucking plate has a gripping hole in a portion adjacent to four sides constituting an appearance of the chucking plate.

13. The apparatus of claim 9, wherein, when the controller operates the magnetic field generator, electrostatic attraction is generated by a magnetic field generated by the magnetic field generator between the chucking plate and the base plate.

14. The apparatus of claim 9, wherein the chucking pad comprises any one material of synthetic rubber and silicone rubber.

15. The apparatus of claim 9, wherein the upper surface of the chucking plate comprises a plurality of fixed grooves having a concave shape and extending in a direction parallel to a direction in which any one side surface of side surfaces constituting the chucking plate extends.

16. The apparatus of claim 9, wherein the chucking plate has a rectangular plate shape, and the lever, the piston, the chucking pad, and the elastic member are arranged in a corner portion of the chucking plate to be symmetrical with respect to a center of the chucking plate.

17. The apparatus of claim 9, wherein the chucking structure further comprises a fixed plate arranged at a corner portion of the upper surface of the chucking plate to support the lever, and the base plate of the hole cutting apparatus is provided between the fixed plates and fixed on the chucking plate.
